(19) United States
(12) Patent Application Publication
(10) Pub. No.: US 2017/0294856 A1
(43) Pub. Date: Oct. 12, 2017

(54) STEPPING MOTOR CONTROL DEVICE AND STEPPING MOTOR CONTROL METHOD FOR CONTROLLING STEPPING MOTOR

(71) Applicant: KYOCERA Document Solutions Inc., Osaka (JP)

(72) Inventor: Naohiro Anan, Osaka (JP)

(21) Appl. No.: 15/485,086

(22) Filed: Apr. 11, 2017

(30) Foreign Application Priority Data
Apr. 12, 2016 (JP) 2016-079271

(51) Int. Cl. H02P 8/12; H02P 8/08

(52) U.S. Cl. CPC H02P 8/12; H02P 8/08

(57) ABSTRACT

A stepping motor control device includes a motor drive portion, a rotor position detection portion, and a control portion. The motor drive portion is configured to sequentially switch an excitation pattern of excitation phases of a stepping motor each time a drive pulse signal is supplied thereto. The rotor position detection portion is configured to be capable of detecting a rotor position in a state where a rotor of the stepping motor has stopped. The control portion is configured to supply the drive pulse signal having a number of pulses determined in accordance with the rotor position detected by the rotor position detection portion, to the motor drive portion in a state where a current supplied to the excitation phases has been controlled to a predetermined current value at which the rotor does not rotate.

### INCORPORATION BY REFERENCE

This application is based upon and claims the benefit of priority from the corresponding Japanese Patent Application No. 2016-079271 filed on Apr. 12, 2016, the entire contents of which are incorporated herein by reference.

### BACKGROUND

The present disclosure relates to a stepping motor control device and a stepping motor control method for controlling a stepping motor.

In a stepping motor, a rotor rotates by an excitation pattern of excitation phases being sequentially switched. That is, the rotor position changes in synchronization of the switching of the excitation pattern.

At the time of start of a stepping motor such as immediately after an apparatus including the stepping motor is turned on, the rotor position is unidentified. Thus, after the stepping motor starts, if the rotor position is deviated from a proper position with respect to the excitation pattern when initial excitation is performed, step-out is caused.

A stepping motor control device is known in which, in order to prevent the above step-out, at the time of start of the stepping motor, by switching the excitation pattern at relatively long time intervals until the excitation pattern of the excitation phases is switched through all excitation patterns, the switching of the excitation pattern and rotation of the rotor are assuredly synchronized with each other.

### SUMMARY

A stepping motor control device according to one aspect of the present disclosure includes a motor drive portion, a rotor position detection portion, and a control portion. The motor drive portion is configured to sequentially switch an excitation pattern of excitation phases of a stepping motor each time a drive pulse signal is supplied thereto. The rotor position detection portion is configured to be capable of detecting a rotor position in a state where a rotor of the stepping motor has stopped. The control portion is configured to supply the drive pulse signal having a number of pulses determined in accordance with the rotor position detected by the rotor position detection portion, to the motor drive portion in a state where a current supplied to the excitation phases has been controlled to a predetermined current value at which the rotor does not rotate.

A stepping motor control method according to another aspect of the present disclosure includes a rotor position detection step, a number-of-pulses determination step, a current control step, and a drive pulse signal supply step. In the rotor position detection step, a rotor position of a stepping motor is detected. In the number-of-pulses determination step, a number of pulses is determined in accordance with the rotor position detected in the rotor position detection step. In the current control step, a current supplied to excitation phases of the stepping motor is controlled to a predetermined current value at which a rotor does not rotate. In the drive pulse signal supply step, a drive pulse signal having the number of pulses determined in the number-of-pulses determination step is supplied to a motor drive portion configured to sequentially switch an excitation pattern of the excitation phases of the stepping motor each time the drive pulse signal is supplied thereto, in a state where the current supplied to the excitation phases has been controlled to the predetermined current value.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing the configuration of a stepping motor control device according to an embodiment of the present disclosure.

FIG. 2 is a diagram showing an example of excitation patterns used in the stepping motor control device according to the embodiment of the present disclosure.

FIG. 3 is a flowchart showing an example of a procedure of an initial phase matching process executed in the stepping motor control device according to the embodiment of the present disclosure.

FIG. 4 is a diagram showing an example of state transition of various signals used in the stepping motor control device according to the embodiment of the present disclosure.

FIG. 5 is a diagram showing an example of a conversion table used in the stepping motor control device according to the embodiment of the present disclosure.

### DETAILED DESCRIPTION

Hereinafter, an embodiment of the present disclosure will be described with reference to the accompanying drawings in order to allow understanding of the present disclosure. It should be noted that the following embodiment is an example embodying the present disclosure, and, by nature, does not limit the technical scope of the present disclosure.

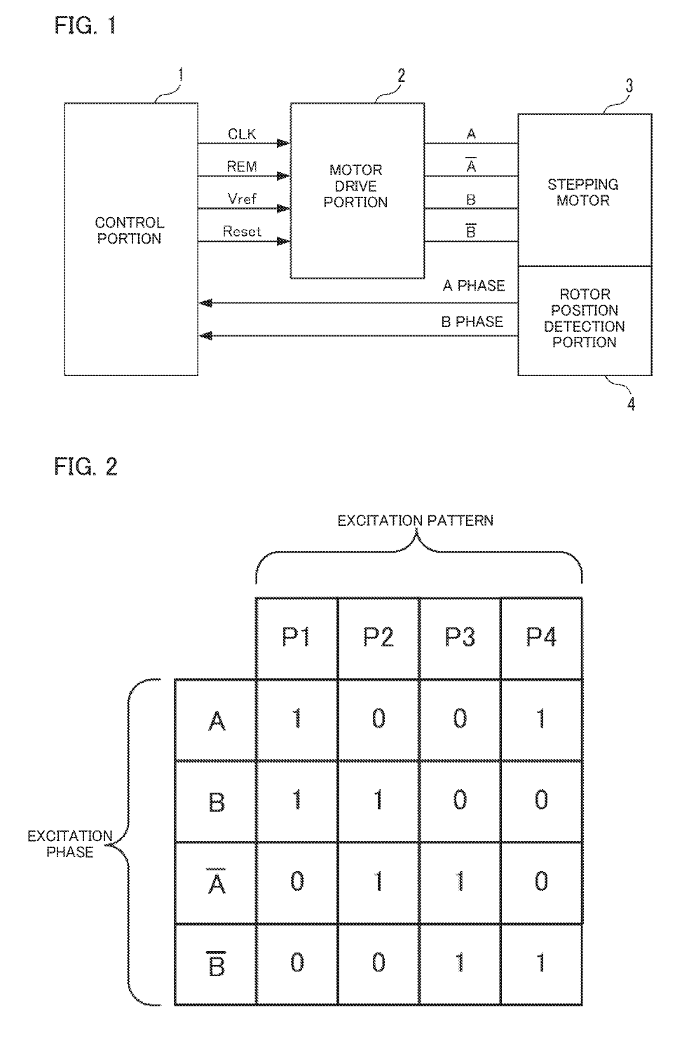

As shown in FIG. 1, a stepping motor control device according to the embodiment of the present disclosure includes a control portion 1, a motor drive portion (motor drive circuit) 2, and a rotor position detection portion 4. The stepping motor control device is used for controlling a stepping motor 3 that is provided, for example, in a drive system of an electrophotographic type image forming apparatus, an image reading apparatus, or the like.

The stepping motor 3 includes a rotor fixed to a motor shaft and a stator provided around the rotor. The rotor includes, for example, permanent magnets. In the stator, a plurality of magnetic poles each having a coil wound are formed at predetermined intervals. By an excitation pattern of these coils being sequentially switched by the motor drive portion 2, the rotor rotates in steps of a certain angle.

The motor drive portion 2 drives the stepping motor 3 by sequentially switching the excitation pattern of excitation phases (the coils) of the stepping motor 3 each time a later-described drive pulse signal CLK (clock pulse) is supplied thereto from the control portion 1. For example, in the case where the stepping motor 3 is driven by a two-phase excitation method, the motor drive portion 2 excites each excitation phase by sequentially switching the excitation pattern in order of P1→P2→P3→P4→P1 . . . as shown in FIG. 2 each time the drive pulse signal CLK is supplied thereto. As a result, the rotor and the motor shaft rotate by a certain angle each time the drive pulse signal CLK is supplied to the motor drive portion 2. The motor drive portion 2 may drive the stepping motor 3 by an excitation method other than the two-phase excitation method, such as a one-two phase excitation method. The motor drive portion 2 includes, for example, a circuit that generates a plurality of phase selection signals on the basis of the drive pulse signal CLK, and a plurality of transistors, switching of which is controlled on the basis of the plurality of phase selection signals. Any publicly-known drive circuit that is used for controlling a stepping motor may be used as the motor drive portion 2.

The control portion 1 controls the motor drive portion 2 by supplying various control signals to the motor drive portion 2. In FIG. 1, the drive pulse signal CLK, an operation permission signal REM, a current command signal Vref, and an excitation pattern reset signal Reset are shown as examples of the control signals. The drive pulse signal CLK is a pulse signal for rotating the rotor in steps of a certain angle. The operation permission signal REM is a control signal for controlling whether to permit drive of the stepping motor 3 by the motor drive portion 2. The current command signal Vref is a control signal for controlling the magnitude of a current supplied to the coils. The excitation pattern reset signal Reset is a control signal for resetting the excitation pattern switched by the motor drive portion 2, to a specific excitation pattern (e.g., an excitation pattern P1 shown in FIG. 2).

The control portion 1 includes control devices such as a CPU, a ROM, and a RAM. The CPU is a processor which executes various calculation processes. The ROM is a non-volatile storage portion in which information such as a control program for causing the CPU to execute various processes (including an initial phase matching process described later) is stored in advance. The RAM is a volatile or non-volatile storage portion used as a temporary storage memory (working area) for various processes executed by the CPU. The control portion 1 may be composed of an integrated circuit such as an ASIC.

The rotor position detection portion 4 is, for example, a Hall element capable of two-phase outputs having a 90 degree phase difference, and is able to detect a rotor position in a state where the rotor of the stepping motor 3 has stopped. As the rotor position detection portion 4, any sensor capable of detecting the rotor position in a state where the rotor of the stepping motor 3 has stopped may be used. For example, an optical sensor may be used as the rotor position detection portion 4.

In the present embodiment, the rotor position detection portion 4 outputs a one-bit digital signal as each of output signals of two phases, that is, of an A phase and a B phase. However, the present disclosure is not limited thereto, and the rotor position detection portion 4 may output a multiple-bit digital signal or an analog signal as the output signal of each phase.

Meanwhile, as described above, in the stepping motor 3, the rotor rotates by the excitation pattern of the excitation phases being sequentially switched. That is, the rotor position changes in synchronization with the switching of the excitation pattern. However, at the time of start of the stepping motor 3 such as immediately after an apparatus including the stepping motor 3 is turned on, the rotor position is unidentified. Thus, after the stepping motor 3 starts, if the rotor position is deviated from a proper position with respect to the excitation pattern when initial excitation is performed, step-out is caused.

A stepping motor control device is known in which, in order to prevent the above step-out, at the time of start of the stepping motor 3, by switching the excitation pattern at relatively long time intervals until the excitation pattern of the excitation phase is switched through all excitation patterns, the rotor position is matched with the excitation pattern. However, in such a stepping motor control device, in order to match the rotor position with the excitation pattern, it is necessary to switch the excitation pattern at relatively long time intervals until the excitation pattern of the excitation phases is switched through all the excitation patterns, so that the starting time period becomes long.

On the other hand, in the stepping motor control device according to the present embodiment, for example, the later-described initial phase matching process is executed at the time of start of the stepping motor 3, that is, at the time at which the motor drive portion 2 is turned on. Accordingly, in the stepping motor control device according to the present embodiment, it is possible to prevent step-out at the time of start without the starting time period becoming long.

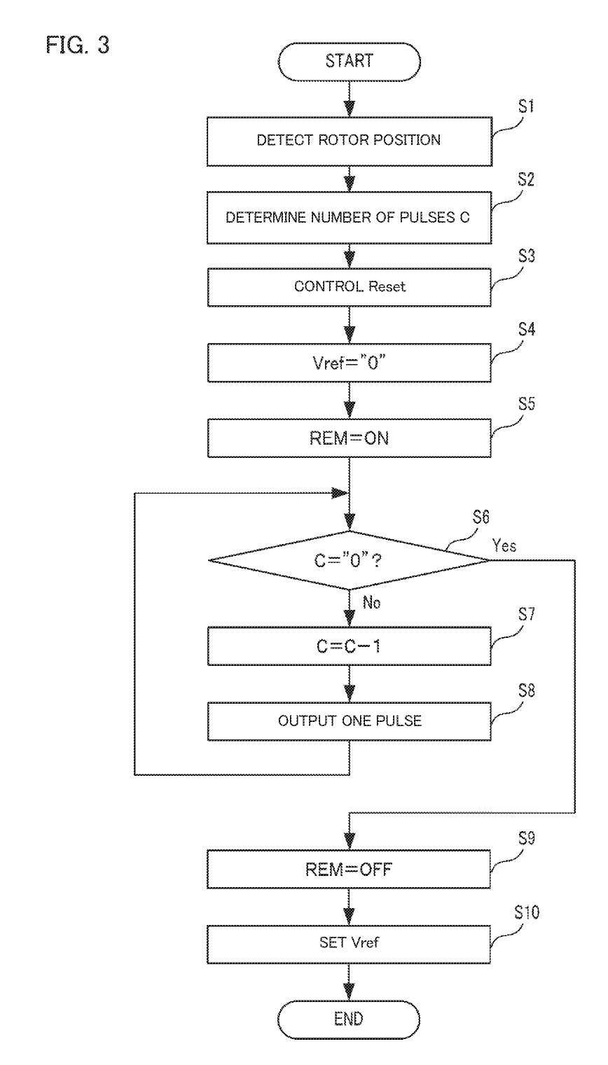

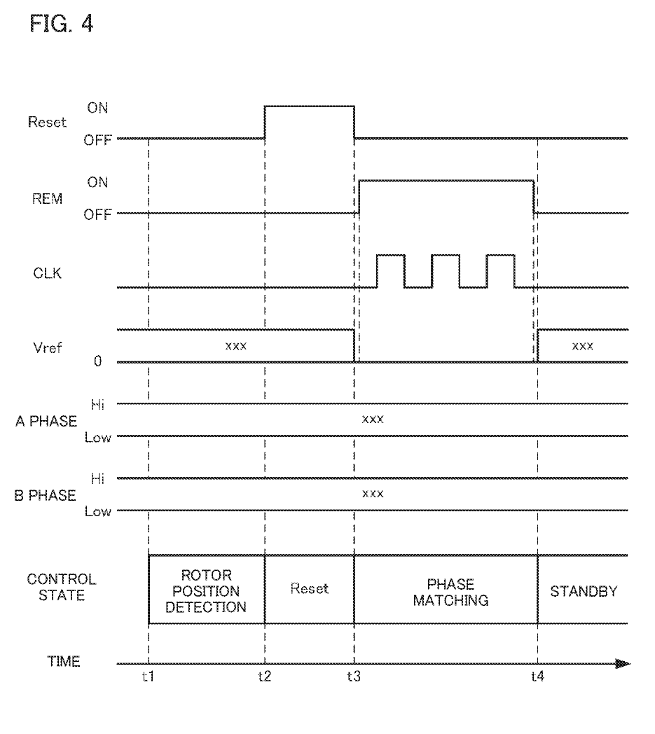

Hereinafter, the initial phase matching process executed by the control portion 1 will be described with reference to FIGS. 3 to 5. FIG. 3 is a flowchart showing an example of a procedure of the initial phase matching process. Here, S1, S2 . . . represent numbers of process procedures (steps) executed by the control portion 1. The initial phase matching process is executed, for example, at the time of start of the stepping motor 3. The time at which the initial phase matching process is executed is not limited to the time at which the motor drive portion 2 is turned on, and the initial phase matching process may be executed as necessary, for example, when it is determined that there is a possibility that the rotor position is deviated with respect to the excitation pattern.

<Step S1>

First, in step S1, the control portion 1 detects the rotor position on the basis of the output signals of the A phase and the B phase from the rotor position detection portion 4. In the present embodiment, the output signal of each phase from the rotor position detection portion 4 is a one-bit digital signal, and is a signal (Hi or Low) corresponding to the present rotor position as shown in FIG. 4. A combination of logical values of the output signals of the respective phases represents the present rotor position. As described later, the rotor position does not change during the initial phase matching process, and thus the logical values of the output signals of the A phase and the B phase from the rotor position detection portion 4 do not change in the middle of this process.

<Step S2>

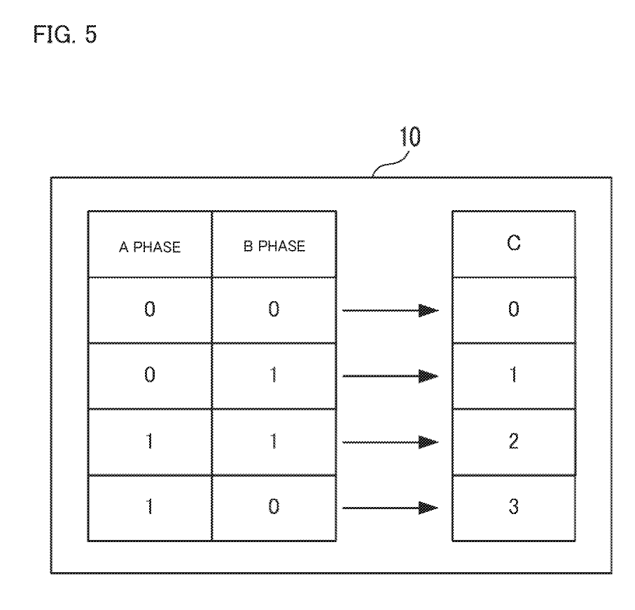

In step S2, the control portion 1 determines a number of pulses C in accordance with the output signal of each phase from the rotor position detection portion 4, for example, by using a conversion table 10 shown in FIG. 5. The number of pulses C represents the number of the pulses of the drive pulse signal CLK to be supplied to the motor drive portion 2 during the period of times t3 to t4 in FIG. 4.

<Step S3>

In step S3, as in the period of times t2 to t3 in FIG. 4, the control portion 1 sets the signal Reset to be “ON” (active) and then returns the signal Reset to “OFF” (non-active). Accordingly, the excitation pattern switched by the motor drive portion 2 is reset to a specific excitation pattern (e.g., the excitation pattern P1 shown in FIG. 2).

<Step S4>

In step S4, the control portion 1 sets a command value of the current command signal Vref to “0”. Accordingly, the current supplied to the coils of the stepping motor 3 temporarily becomes 0. Thus, even when the drive pulse signal CLK is supplied to the motor drive portion 2 in step S8 described later, the excitation pattern is merely switched but the rotor does not rotate. In the present embodiment, the command value of the current command signal Vref is set to “0”, but the current supplied to the coils of the stepping motor 3 may be controlled to a sufficiently low current value at which the rotor does not rotate. In the periods other than times t3 to t4 shown in FIG. 4, the current command signal Vref may be set to an arbitrary command value.

<Step S5>

In step S5, the control portion 1 sets the operation permission signal REM to be ON (active). Accordingly, an operation of switching the excitation pattern by the motor drive portion 2 is permitted.

<Step S6>

In step S6, the control portion 1 determines whether the present number of pulses C (i.e., the number of pulses C determined in step S2 or a number of pulses after update in step S7) is 0. Then, if it is determined that the number of pulses C is 0 (S6: Yes), the process proceeds to step S9. On the other hand, when it is determined that the number of pulses C is not 0 (S6: No), the process proceeds to step S7.

<Step S7>

In step S7, the control portion 1 subtracts 1 from the present number of pulses C to update the number of pulses C.

<Step S8>

In step S8, the control portion 1 supplies the drive pulse signal CLK of one pulse to the motor drive portion 2. Accordingly, the excitation pattern advances by one step. That is, the excitation pattern is switched from the present excitation pattern to the next excitation pattern. Then, the process returns to step S6.

Until the number of pulses C becomes 0, the processes in steps S6 to S8 are repeated. As a result, as shown in FIG. 4, pulse signals the number of which is equal to the number of pulses C determined in step S2 are supplied as the drive pulse signal CLK to the motor drive portion 2. FIG. 4 illustrates the case where the number of pulses C is “3”.

The number of pulses C in the conversion table 10 shown in FIG. 5 is set to a number of pulses required for matching the phase of the excitation pattern with the rotor position. For example, in the case where an excitation pattern corresponding to a rotor position at which the logical value of the output signal of the A phase is “1” and the logical value of the output signal of the B phase is “0” is an excitation pattern P4 shown in FIG. 2, the phase of the excitation pattern can be matched with the rotor position by advancing the excitation pattern from the excitation pattern P1 (specific excitation pattern) by three steps. Accordingly, for example, in the conversion table 10, “3” is set as the number of pulses C corresponding to the rotor position at which the logical value of the output signal of the A phase is “1” and the logical value of the output signal of the B phase is “0”.

By the processes in steps S6 to S8, the drive pulse signal CLK corresponding to the number of pulses C which is determined in accordance with the rotor position detected by the rotor position detection portion 4 is supplied to the motor drive portion 2 in a state where the current supplied to the excitation phases has been controlled to a predetermined current value at which the rotor does not rotate. Specifically, in a state where the current supplied to the excitation phases has been controlled to 0, the drive pulse signal CLK corresponding to the number of pulses C is supplied to the motor drive portion 2. Accordingly, the phase of the excitation pattern and the rotor position are matched with each other by only the excitation pattern being switched without the rotor rotating.

<Step S9>

In step S9, the control portion 1 sets the operation permission signal REM to be “OFF” (non-active) to shift to a standby state as shown in FIG. 4.

<Step S10>

In step S10, the control portion 1 sets the command value of the current command signal Vref to a desired value as necessary. Then, the initial phase matching process ends.

Step S1 is an example of a rotor position detection step of the present disclosure. Step S2 is an example of a number-of-pulses determination step of the present disclosure. Step S4 is an example of a current control step of the present disclosure. Steps S6 to S8 are an example of a drive pulse signal supply step of the present disclosure.

The flowchart shown in FIG. 3 is merely one example, and a part of the processes may be omitted, or the order of the processes may be changed. For example, the processes in steps 51 and S2 may be executed immediately before the process in step S6.

By the initial phase matching process described above, a shift is made to the standby state in a state where the rotor position and the excitation pattern have been matched with each other. Thus, it is possible to prevent step-out of the stepping motor 3. In addition, in the initial phase matching process, a process of switching the excitation pattern at relatively long time intervals for synchronizing the excitation pattern and the rotor is not necessary, so that the starting time period can be shortened.

As described above, in the present embodiment, after the number of pulses C is determined on the basis of the conversion table 10 indicating a correspondence relationship between the number of pulses C and the rotor position detected by the rotor position detection portion 4, and the excitation pattern switched by the motor drive portion 2 is reset to the specific excitation pattern P1, the drive pulse signal CLK corresponding to the number of pulses C is supplied to the motor drive portion 2. However, the present disclosure is not limited thereto. For example, in the case where the control portion 1 can acquire the present excitation pattern from the motor drive portion 2, the control portion 1 may calculate a number of pulses required for switching from the present excitation pattern to an excitation pattern corresponding to the rotor position detected by the rotor position detection portion 4, and may supply the drive pulse signal CLK corresponding to this number of pulses, to the motor drive portion 2.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A stepping motor control device comprising:
a motor drive portion configured to sequentially switch an excitation pattern of excitation phases of a stepping motor each time a drive pulse signal is supplied thereto;
a rotor position detection portion configured to be capable of detecting a rotor position in a state where a rotor of the stepping motor has stopped; and
a control portion configured to supply the drive pulse signal having a number of pulses determined in accordance with the rotor position detected by the rotor position detection portion, to the motor drive portion in a state where a current supplied to the excitation phases has been controlled to a predetermined current value at which the rotor does not rotate.

2. The stepping motor control device according to claim 1, wherein the control portion supplies the drive pulse signal having the number of pulses to the motor drive portion in a state where the current supplied to the excitation phases has been controlled to 0.

3. The stepping motor control device according to claim 1, wherein after the control portion determines the number of pulses on the basis of a conversion table indicating a correspondence relationship between the number of pulses and the rotor position detected by the rotor position detection portion and resets the excitation pattern switched by the motor drive portion to a specific excitation pattern, the control portion supplies the drive pulse signal having the number of pulses to the motor drive portion.

4. The stepping motor control device according to claim 1, wherein the control portion supplies the drive pulse signal having the number of pulses to the motor drive portion at least at a time at which the motor drive portion is turned on.

5. The stepping motor control device according to claim 1, wherein the rotor position detection portion includes a Hall element.

6. A stepping motor control method comprising:
a rotor position detection step of detecting a rotor position of a stepping motor;
a number-of-pulses determination step of determining a number of pulses in accordance with the rotor position detected in the rotor position detection step;
a current control step of controlling a current supplied to excitation phases of the stepping motor, to a predetermined current value at which a rotor does not rotate; and
a drive pulse signal supply step of supplying a drive pulse signal having the number of pulses determined in the number-of-pulses determination step to a motor drive portion configured to sequentially switch an excitation pattern of the excitation phases of the stepping motor each time the drive pulse signal is supplied thereto, in a state where the current supplied to the excitation phases has been controlled to the predetermined current value.
